(19) United States
(12) Patent Application Publication
(10) Pub. No.: US 2007/0144563 A1
(43) Pub. Date: Jun. 28, 2007

(54) SUBSTRATE TREATMENT APPARATUS AND SUBSTRATE TREATMENT METHOD

(76) Inventor: Hiroyuki Araki, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/614,382

(22) Filed: Dec. 21, 2006

(30) Foreign Application Priority Data
Dec. 28, 2005 (JP) 2005-379664

(51) Int. Cl. B08B 3/00

(52) U.S. Cl. 134/84; 134/900

(57) ABSTRACT

A substrate treatment apparatus includes a substrate holding mechanism, a substrate attitude changing mechanism which changes the attitude of a substrate held by the substrate holding mechanism between a generally horizontal attitude and a tilted attitude in which the substrate is tilted with respect to a horizontal plane, a treatment liquid supplying mechanism which is capable of supplying a plurality of treatment liquids to the substrate, a plurality of treatment liquid receiving portions which each receive a corresponding one of the treatment liquids flowing down from a surface of the substrate when the substrate is brought into the tilted attitude, and a receiving portion selecting unit which selects one of the treatment liquid receiving portions according to the type of a treatment liquid present on the substrate for receiving the treatment liquid flowing down from the substrate.

### BACKGROUND OF THE INVENTION

1. Field of the Invention

The present invention relates to a substrate treatment apparatus and a substrate treatment method for treating a substrate with a treatment liquid. Examples of the substrate to be treated include semiconductor wafers, substrates for liquid crystal display devices, substrates for plasma display devices, substrates for FEDs (field emission display devices), substrates for optical disks, substrates for magnetic disks, substrates for magneto-optical disks, and substrates for photo masks.

2. Description of the Related Art

In a semiconductor device production process, a substrate treatment apparatus is generally used, which is adapted to supply a treatment liquid (a chemical agent or a rinse liquid) to a surface of a semiconductor wafer (a substrate to be treated). Particularly, a substrate treatment apparatus of a single substrate treatment type adapted to treat a single substrate at a time includes a spin chuck which horizontally holds and rotates the substrate, an agent nozzle which supplies a chemical agent to the substrate held by the spin chuck, a water nozzle which supplies pure water (deionized water) as a rinse liquid to the substrate held by the spin chuck, and a guard surrounding the spin chuck.

With this arrangement, a chemical agent treatment is performed by supplying the chemical agent from the agent nozzle to the substrate rotated by the spin chuck. Then, the supply of the chemical agent is stopped, and a rinsing operation is performed by supplying the deionized water from the water nozzle onto the rotating substrate. Thereafter, the supply of the deionized water is stopped, and a drying operation is performed by rotating the spin chuck at a high speed for spinning off the water from the substrate. The treatment liquids scattered from the substrate by centrifugal forces during the chemical agent treatment, the rinsing operation and the drying operation are received by the guard.

In a certain case, the guard includes an agent receiving portion and a water receiving portion (see, for example, Japanese Unexamined Patent Publication No. 10(1998)-172950). In this case, the chemical agent is received in the agent receiving portion and recovered in an agent tank for reuse, while the water is received in the water receiving portion and drained into drainage of a plant.

With the aforesaid arrangement, the substrate is rotated for removing the treatment liquid (the chemical agent or the water) from the substrate held horizontally and, therefore, the guard is essential for suppressing the scattering of the treatment liquid. This complicates the construction of the substrate treatment apparatus, and increases the production costs.

Further, the treatment liquid is scattered in the form of liquid droplets from the substrate. For example, droplets of the chemical agent are liable to intrude into the water receiving portion, and droplets of the water are liable to intrude into the agent receiving portion. Thus, contamination of the treatment liquids occurs, whereby the chemical agent is recovered at a reduced recovery rate or diluted.

Further, a motor should be provided for rotating the substrate at a high speed, thereby requiring measures for preventing generation of dust from peripheral components of the motor. This increases the complication and size of a mechanism provided below the spin chuck, and correspondingly increases the costs. In addition, the spin chuck should include a firm support member (support pins) which is capable of bearing a load applied thereto during the high speed rotation for stably holding the substrate rotated at a high speed. This also prevents the cost reduction. Further, the substrate is subjected to a great load during the high speed rotation, so that the degradation of the substrate due to the load cannot be neglected.

If the treatment liquid (particularly, the chemical agent) adheres to an interior wall of the guard and components in a treatment chamber, the adhering treatment liquid diffuses into the atmosphere to deteriorate the quality of the substrate treatment.

With the aforesaid arrangement, the surface of the substrate (generally rotated at a rotation speed of several tens to several hundreds rpm) should be covered with the treatment liquid for uniform in-plane treatment. Therefore, great amounts of the chemical agent and the deionized water should be supplied onto the rotating substrate (at a flow rate of several liters per minute). Thus, the consumption of the treatment liquids and hence the running costs are increased.

### SUMMARY OF THE INVENTION

It is an object of the present invention to provide a substrate treatment apparatus and a substrate treatment method which ensure that treatment liquids are each properly removed from a substrate and separately drained with a simple construction, thereby permitting cost reduction.

It is another object of the present invention to provide a substrate treatment apparatus and a substrate treatment method which suppress the diffusion of an adhering treatment liquid in the atmosphere for the improvement of the quality of the substrate treatment.

It is further another object of the present invention to provide a substrate treatment apparatus and a substrate treatment method which reduce the consumption of treatment liquids to reduce the running costs.

A substrate treatment apparatus according to the present invention includes a substrate holding mechanism (1) which holds a substrate (W), a substrate attitude changing mechanism (2) which changes the attitude of the substrate held by the substrate holding mechanism between a generally horizontal attitude and a tilted attitude in which the substrate is tilted with respect to a horizontal plane, a treatment liquid supplying mechanism (11,12,13A,13B) which is capable of supplying a plurality of treatment liquids to the substrate held by the substrate holding mechanism, a controlling unit (10) which controls the substrate attitude changing mechanism so as to bring the substrate into the horizontal attitude when one of the treatment liquids is to be supplied onto the substrate held by the substrate holding mechanism from the treatment liquid supplying mechanism; a plurality of treatment liquid receiving portions (21,22,23,61,62,63) which each receive a corresponding one of the treatment liquids flowing down from a surface of the substrate when the substrate held by the substrate holding mechanism is brought into the tilted attitude by the substrate attitude changing mechanism, and a receiving portion selecting unit (10,8,46,66) which selects, according to the type of a treatment liquid present on the substrate held by the substrate holding mechanism, one of the treatment liquid receiving portions that is to receive the treatment liquid flowing down from the substrate kept in the tilted attitude. Parenthesized alphanumeric characters respectively denote corresponding components in embodiments to be described later, but are not intended to limit the present invention to these embodiments. This definition is ditto for the following description.

With the aforementioned arrangement, the treatment liquid is drained from the substrate by bringing the substrate into the tilted attitude without rotating the substrate. The treatment liquids each flowing down from the substrate are separately drained into the corresponding treatment liquid receiving portions. Thus, separate drainage of the treatment liquids is achieved. As compared with the case in which the treatment liquid is removed from the substrate surface by rotating the substrate at a high speed, the scattering of the treatment liquid removed from the substrate can be suppressed, obviating the need for the provision of the guard. This simplifies the construction of the substrate treatment apparatus and reduces the costs, while ensuring advantageous separate drainage of the plural treatment liquids. Since the scattering of the treatment liquid during the removal of the treatment liquid can be suppressed, it is possible to suppress the adhesion of the treatment liquid to peripheral components and hence the diffusion of the adhering treatment liquid in the atmosphere. This improves the quality of the substrate treatment.

Further, the substrate attitude changing mechanism is controlled so as to bring the substrate into the horizontal attitude when one of the treatment liquid is to be supplied onto the substrate; therefore, the treatment liquid puddle can be formed on the substrate. This suppresses the consumption of the treatment liquid and reduces the running costs.

The treatment liquid supplying mechanism may include a plurality of nozzles which supply the respective treatment liquids, or may include a single common nozzle which selectively supplies the treatment liquids via a valve mechanism connected thereto.

The substrate holding mechanism is preferably adapted to hold the substrate in a non-rotative state in a period during which the substrate surface is covered with one of the treatment liquids (preferably in the entire treatment period). With this arrangement, the substrate is held in the non-rotative state at least in the period during which the substrate surface is covered with the treatment liquid, so that the treatment liquid is not scattered around. This obviates the need for the provision of the guard. Further, it is unnecessary to provide a substrate high speed rotating mechanism for rotating the substrate at a high speed, thereby obviating the need for measures against the generation of dust from the substrate high speed rotating mechanism. This further simplifies the construction of the substrate treatment apparatus and hence reduces the costs. Further, a puddle of the treatment liquid can be formed on an upper surface of the substrate by horizontally holding the substrate in the non-rotative state. By thus forming the treatment liquid puddle for the treatment of the substrate, the consumption of the treatment liquid and hence the running costs can be reduced.

When one of the treatment liquids is to be supplied onto the substrate held by the substrate holding mechanism from the treatment liquid supplying mechanism, the controlling unit preferably controls the supply of the one treatment liquid from the treatment liquid supplying mechanism and controls the substrate attitude changing mechanism to bring the substrate into the horizontal attitude for retaining a puddle of the one treatment liquid on the substrate for a predetermined period for treatment of the substrate. With this arrangement, the substrate is treated by retaining the treatment liquid puddle on the substrate held in the horizontal attitude for the predetermined period. Thus, the amount of the treatment liquid to be used for the substrate treatment can be significantly reduced, thereby reducing the running costs of the substrate treatment apparatus.

The controlling unit (10) may be capable of, when one of the treatment liquids is to be supplied onto the substrate held by the substrate holding mechanism from the treatment liquid supplying mechanism, controlling the substrate attitude changing mechanism so as to bring the substrate into the tilted attitude. With this arrangement, the treatment liquid can be supplied onto the substrate held in the tilted attitude. At this time, a stream of the treatment liquid is formed on the substrate. Thus, the substrate is treated by constantly supplying the treatment liquid over the entire substrate without rotating the substrate. In this case, the treatment liquid supplying mechanism which supplies the treatment liquid onto the substrate held in the tilted attitude is preferably a nozzle (side nozzle) which supplies the treatment liquid toward the upper surface of the substrate from a lateral side of the substrate.

The treatment liquid receiving portions may be arranged along an outer periphery of the substrate held by the substrate holding mechanism. In this case, the receiving portion selecting unit preferably includes a flow-down position/receiving position relative movement mechanism (5,6,7,8,46) which changes a treatment liquid flow-down position relative to the treatment liquid receiving portions along the outer periphery of the substrate before the treatment liquid flows down from the substrate kept in the tilted attitude by the substrate attitude changing mechanism. With this arrangement, the treatment liquids can be separately drained into the corresponding treatment liquid receiving portions by changing the treatment liquid flow-down position relative to the treatment liquid receiving portions along the outer periphery of the substrate.

The flow-down position/receiving position relative movement mechanism may include a tilt direction changing mechanism (5,6,7,8) which changes a substrate tilt direction in which the substrate is tilted by the substrate attitude changing mechanism. With this arrangement, the treatment liquid flow-down position can be changed along the outer periphery of the substrate by changing the substrate tilt direction, so that the treatment liquids can be separately drained with a simple construction.

The substrate holding mechanism may include at least three substrate support members (31,32,33) which support a lower surface of the substrate. In this case, the substrate attitude changing mechanism may include a substrate support level changing mechanism (5,6,7) which relatively changes substrate support levels of the at least three substrate support members at which the substrate is supported by the respective substrate support members, and the tilt direction changing mechanism may be adapted to control the substrate support level changing mechanism to adjust the substrate support levels of the at least three substrate support members for changing the substrate tilt direction. With this simple arrangement, the substrate tilt direction can be changed by relatively changing the substrate support levels of the respective substrate support members. Where the substrate is supported at three positions around the center of the substrate by the three substrate support members, the substrate is brought into the tilted attitude, for example, by setting one of the substrate support members at a higher substrate support level than the other two substrate support members or by setting two of the substrate support members at a higher or lower substrate support level than the other substrate support member. In this case, where the substrate support levels of the three substrate support members are independently changed, for example, three choices are provided for setting one of the three substrate support members at a higher substrate support level. Therefore, the substrate tilt direction can be selected from three directions.

Alternatively, the substrate treatment apparatus may be arranged such that the attitude of the substrate held by the substrate holding mechanism is changed between the horizontal attitude and the tilted attitude by moving up and down a portion of the outer periphery of the substrate by means of the substrate support members and the tilt direction of the substrate held in the tilted attitude is changed along the outer periphery of the substrate by rotating the substrate holding mechanism.

The flow-down position/receiving position relative movement mechanism may include a receiving portion rotating mechanism (45,46) which rotates the plurality of treatment liquid receiving portions along the outer periphery of the substrate held by the substrate holding mechanism. With this arrangement, the treatment liquids can be separately drained into the corresponding treatment liquid receiving portions by rotating the treatment liquid receiving portions along the outer periphery of the substrate according to the treatment liquid flow-down position of the substrate.

The treatment liquid receiving portions may be arranged in vertically stacked relation on a lateral side of the substrate holding mechanism. In this case, the receiving portion selecting unit may include a flow-down position/receiving position relative movement mechanism (52,66) which, before the treatment liquid flows down from the substrate kept in the tilted attitude by the substrate attitude changing mechanism, changes the treatment liquid flow-down position relative to the treatment liquid receiving portions for receiving the treatment liquid. With this arrangement, the treatment liquid receiving portions are stacked on the lateral side of the substrate holding mechanism, so that the footprint of the substrate treatment apparatus can be reduced. The flow-down position/receiving position relative movement mechanism preferably includes a mechanism which changes a vertical position of the substrate holding mechanism relative to the treatment liquid receiving portions.

The flow-down position/receiving position relative movement mechanism may include a substrate moving mechanism (52) which moves the substrate holding mechanism relative to the treatment liquid receiving portions. With this arrangement, one of the treatment liquid receiving portions is selected by moving the substrate holding mechanism relative to the treatment liquid receiving portions, whereby the treatment liquid flowing down from the substrate can be drained into the selected treatment liquid receiving portion.

The flow-down position/receiving position relative movement mechanism may include a receiving portion moving mechanism (66) which moves the treatment liquid receiving portions relative to the substrate holding mechanism. With this arrangement, one of the treatment liquid receiving portions is selected by moving the treatment liquid receiving portions relative to the substrate holding mechanism, whereby the treatment liquid flowing down from the substrate can be drained into the selected treatment liquid receiving portion. In this case, the treatment liquid receiving portions may be unitarily moved, or the selected one of the treatment liquid receiving portions may be moved to the treatment liquid flow-down position of the substrate.

The substrate treatment apparatus preferably further includes a treatment liquid guide member (61b,62b,63b) which guides the treatment liquid flowing down from the substrate kept in the tilted attitude by the substrate attitude changing mechanism into the corresponding treatment liquid receiving portion. With this arrangement, the treatment liquid is efficiently guided from the substrate to the treatment liquid receiving portion by the treatment liquid guide member.

The treatment liquid guide member is preferably arranged to be brought into contact with the treatment liquid flowing down from the substrate without contact with the substrate. With this arrangement, it is possible to efficiently guide the treatment liquid from the substrate to the treatment liquid receiving portion, while suppressing or preventing breakage or contamination of the substrate due to the contact between the treatment liquid guide member and the substrate.

The substrate treatment apparatus preferably further includes an infrared emitting mechanism (35) which emits infrared radiation toward the substrate held by the substrate holding mechanism. With this arrangement, the substrate can be dried by evaporating liquid on the substrate by the infrared radiation without the high speed rotation of the substrate. In this case, the substrate treatment apparatus preferably further includes a filter plate (37) disposed between the infrared emitting mechanism and the substrate held by the substrate holding mechanism, and capable of absorbing a predetermined infrared wavelength region for which the substrate held by the substrate holding mechanism is absorptive and transmitting the other infrared wavelength region of the infrared radiation emitted from the infrared emitting mechanism. This makes it possible to cause the liquid on the substrate surface to absorb the infrared radiation to be evaporated, while suppressing the temperature rise of the substrate. Thus, it is possible to suppress the elution of a substrate material from the substrate due to the temperature rise of the substrate and hence the formation of water marks on the substrate surface.

A substrate treatment method according to the present invention includes the steps of: supplying a plural types of treatment liquids, in sequence, onto a substrate (W) in a generally horizontal attitude; holding the substrate in a tilted attitude to cause each of the treatment liquids to flow down from the substrate; and receiving the treatment liquid flowing down from the substrate held in the tilted attitude in a treatment liquid receiving portion selected from a plurality of treatment liquid receiving portions (21,22,23,61,62,63) according to the type of the treatment liquid to be received. As in the case of the inventive substrate treatment apparatus, various modifications may be made to the inventive substrate treatment method.

The foregoing and other objects, features and effects of the present invention will become more apparent from the following detailed description of preferred embodiments with reference to the attached drawings.

### BRIEF DESCRIPTION OF THE DRAWINGS

FIG. 1 is a schematic sectional view for explaining the construction of a substrate treatment apparatus according to a first embodiment of the present invention.

FIG. 2 is a schematic plan view of the substrate treatment apparatus.

FIG. 3 is a block diagram for explaining an arrangement for controlling the substrate treatment apparatus.

FIG. 4 is a schematic diagram for explaining an exemplary process sequence for treatment of a substrate.

FIG. 5 is a flow chart for explaining operations to be performed by the substrate treatment apparatus according to the process sequence shown in FIG. 4.

FIG. 6 is a schematic sectional view for explaining the construction of a substrate treatment apparatus according to a second embodiment of the present invention.

FIG. 7 is a schematic sectional view for explaining the construction of a substrate treatment apparatus according to a third embodiment of the present invention.

FIG. 8 is a schematic sectional view for explaining the construction of a substrate treatment apparatus according to a fourth embodiment of the present invention.

FIG. 9 is a schematic plan view of the substrate treatment apparatus of FIG. 8.

### DETAILED DESCRIPTION OF PREFERRED EMBODIMENTS

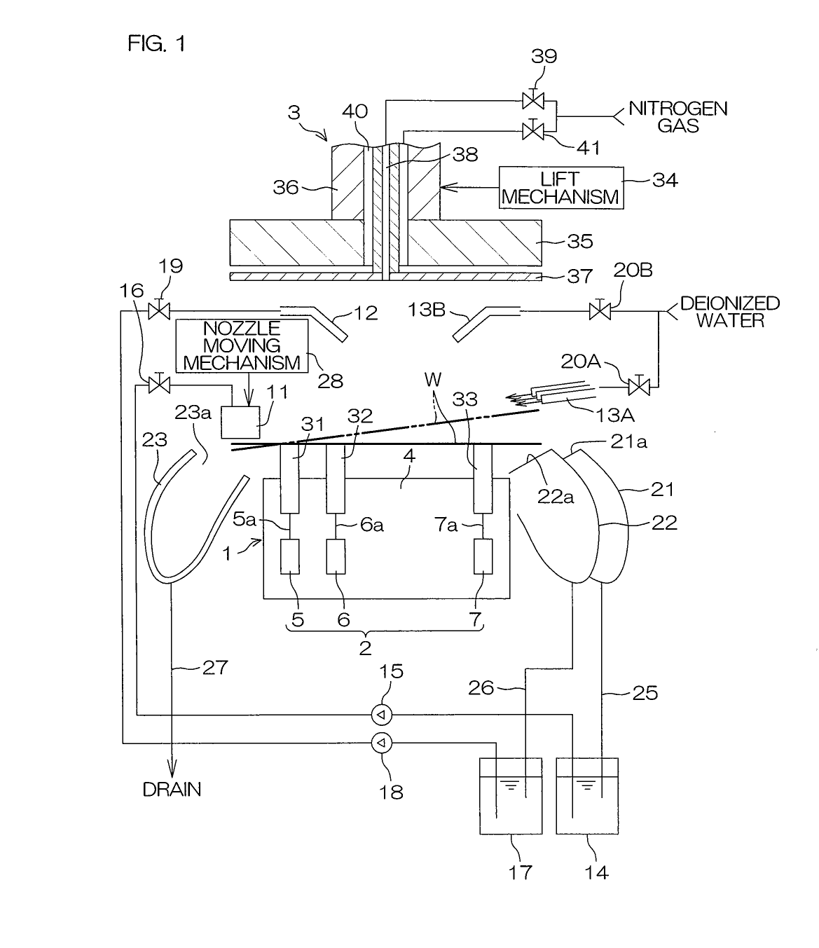

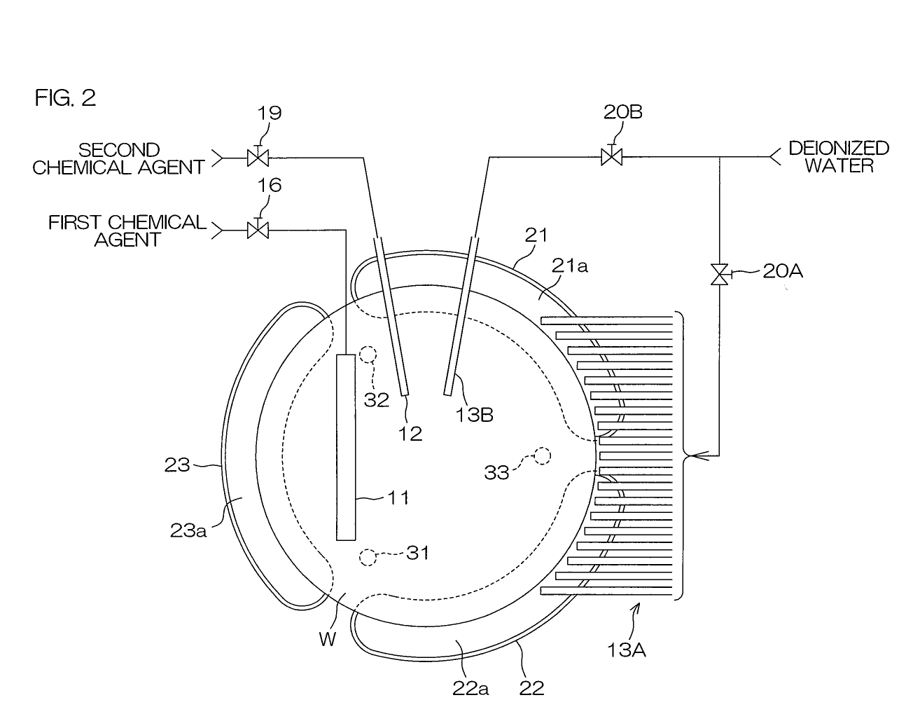

FIG. 1 is a schematic sectional view for explaining the construction of a substrate treatment apparatus according to a first embodiment of the present invention, and FIG. 2 is a schematic plan view of the substrate treatment apparatus. The substrate treatment apparatus is of a single substrate treatment type for treating a generally round substrate W such as a semiconductor wafer with a treatment liquid such as a chemical agent or a rinse liquid. The substrate W may be a substrate having a hydrophobic front surface (device formation surface) such as a silicon wafer having a low-k film formed on a front surface thereof or a silicon wafer having a front surface etched with an etching solution such as hydrofluoric acid.

The substrate treatment apparatus includes a substrate holding mechanism 1 which holds a single substrate W, a substrate attitude changing mechanism 2 which changes the attitude of the substrate W held by the substrate holding mechanism 1 between a horizontal attitude and a tilted attitude, a first agent nozzle 11 which supplies a first chemical agent onto an upper surface of the substrate W held by the substrate holding mechanism 1, a second agent nozzle 12 which supplies a second chemical agent onto the upper surface of the substrate W held by the substrate holding mechanism 1, first and second water nozzles 13A, 13B which each supply deionized water as a rinse liquid onto the upper surface of the substrate W held by the substrate holding mechanism 1, first to third treatment liquid receiving portions 21, 22, 23 which each receive a treatment liquid flowing down from the surface of the substrate W by gravity when the substrate W is held in the tilted attitude, and a substrate drying unit 3 which dries the substrate W held by the substrate holding mechanism 1. In FIG. 2, the substrate treatment apparatus except the substrate drying unit 3 is shown in plan.

The substrate holding mechanism 1 is adapted to hold the substrate W in a non-rotative state with a device formation surface of the substrate W facing up. The substrate holding mechanism 1 includes a base 4, and three support pins 31, 32, 33 projecting upward from an upper surface of the base 4. The support pins 31, 32, 33 are located at positions defined by three vertices of a given equilateral triangle having a gravity center coinciding with the center of the substrate W (in FIG. 1, the support pins 31, 32, 33 are illustrated as located at positions different from actual positions for convenience). These support pins 31, 32, 33 each extend vertically, and are attached to the base 4 in a vertically movable manner. The support pins 31, 32, 33 are adapted to support the substrate W with their heads abutting against a lower surface of the substrate W.

The substrate attitude changing mechanism 2 includes cylinders 5, 6, 7 which respectively move up and down the support pins 31, 32, 32. Drive shafts 5a, 6a, 7a of the cylinders 5, 6, 7 are respectively connected to the support pins 31, 32, 33. Therefore, the support pins 31, 32, 33 are independently moved up and down by driving the cylinders 5, 6, 7, whereby substrate support levels of the support pins 31, 32, 33 are independently changed. Thus, the cylinders 5, 6, 7 function as a substrate support level changing mechanism.

By driving the cylinder 5, the support pin 31 is set at a higher substrate support level than the other two support pins 32, 33, whereby the substrate W is held in the tilted attitude to be tilted down from the support pin 31 toward the center of the substrate W (e.g., at an angle of 3 degrees with respect to a horizontal plane). Similarly, where the support pin 32 is set at a higher substrate support level than the other two support pins 31, 33, the substrate W is held in the tilted attitude to be tilted down from the support pin 32 toward the center of the substrate W. Further, where the support pin 33 is set at a higher substrate support level than the other two support pins 31, 32, the substrate W is held in the tilted attitude to be tilted down from the support pin 33 toward the center of the substrate W. The operations of the cylinders 5, 6, 7 are thus controlled to change the attitude of the substrate W from the horizontal attitude to the tilted attitude and select one of three tilt directions of the substrate held in the tilted attitude.

The first to third treatment liquid receiving portions 21, 22, 23 are fixedly arranged along the outer periphery of the substrate W held by the substrate holding mechanism 1. More specifically, the first to third treatment liquid receiving portions 21, 22, 23 respectively have arcuate drain ports 21a, 22a, 23a each extending across an about 120-degree angular range below the outer periphery of the substrate W (in FIG. 1, the first to third treatment liquid receiving portions 21, 22, 23 are illustrated as located at positions different from actual positions for convenience). The first to third treatment liquid receiving portions 21, 22, 23 are each provided in a trench form, and adapted to receive the treatment liquid flowing down from the outer periphery of the substrate W. The first treatment liquid receiving portion 21 is opposed to the support pin 31 with the center of the substrate W being located therebetween. That is, the drain port 21a of the first treatment liquid receiving portion 21 has a center located in a vertical plane extending through the support pin 31 and the center of the substrate W. Similarly, the second treatment liquid receiving portion 22 is opposed to the support pin 32 with the center of the substrate W being located therebetween. That is, the drain port 22a of the second treatment liquid receiving portion 22 has a center located in a vertical plane extending through the support pin 32 and the center of the substrate W. Further, the third treatment liquid receiving portion 23 is opposed to the support pin 33 with the center of the substrate W being located therebetween. That is, the drain port 23a of the third treatment liquid receiving portion 23 has a center located in a vertical plane extending through the support pin 33 and the center of the substrate W.

Because of the aforesaid positional relationships between the support pins 31, 32, 33 and the first to third treatment liquid receiving portions 21, 22, 23, the attitude of the substrate W is changed in the following manner. The substrate W is held in the tilted attitude to be tilted down toward the first treatment liquid receiving portion 21 by setting the support pin 31 at a higher level than the support pins 32, 33. The substrate W is held in the tilted attitude to be tilted down toward the second treatment liquid receiving portion 22 by setting the support pin 32 at a higher level than the support pins 31, 33. The substrate W is held in the tilted attitude to be tilted down toward the third treatment liquid receiving portion 23 by setting the support pin 33 at a higher level than the support pins 31, 32.

The first agent nozzle 11 is an elongated slit nozzle which is movable along the surface of the substrate W and has an elongated slit provided in a lower surface thereof for spouting the chemical agent. The first chemical agent is pumped up from a first agent tank 14 by a pump 15, and supplied into the first agent nozzle 11 via an agent valve 16. The first agent nozzle 11 is capable of supplying the first chemical agent onto the substrate W, while being moved by a nozzle moving mechanism 28 along the upper surface of the substrate W held by the substrate holding mechanism 1 for scanning the upper surface of the substrate W. With this arrangement, even if the first chemical agent is a viscous chemical agent such as sulfuric acid, the first chemical agent can be evenly spread over the entire upper surface of the substrate W.

The second agent nozzle 12 is a straight nozzle for supplying the chemical agent toward a center portion of the substrate W. The chemical agent to be supplied from the second agent nozzle 12 is a chemical agent, such as an ammonia/hydrogen peroxide solution mixture, having a relatively low viscosity. The second chemical agent is pumped up from the second agent tank 17 by a pump 18, and supplied into the second agent nozzle 12 via an agent valve 19.

One end of an agent recovery pipe 25 is connected to the first treatment liquid receiving portion 21, and the other end of the agent recovery pipe 25 is connected to the first agent tank 14. One end of an agent recovery pipe 26 is connected to the second treatment liquid receiving portion 22, and the other end of the agent recovery pipe 26 is connected to the second agent tank 17. Therefore, the treatment liquid received in the first treatment liquid receiving portion 21 is recovered in the first agent tank 14 via the agent recovery pipe 25, and the treatment liquid received in the second treatment liquid receiving portion 22 is recovered in the second agent tank 17 via the agent recovery pipe 26.

One end of a drain pipe 27 is connected to the third treatment liquid receiving portion 23, and the other end of the drain pipe 27 is connected to drainage of a plant in which the substrate treatment apparatus is installed.

Deionized water is supplied from a deionized water supply source into the first and second water nozzles 13A, 13B via water valves 20A, 20B, respectively. In this embodiment, the first water nozzle 13A includes a plurality of side nozzles which supply the deionized water from a lateral side onto the upper surface of the substrate W held by the substrate holding mechanism 1. Outlet ports of the side nozzles are arranged arcuately along the outer periphery of the substrate W, and the deionized water is spouted generally parallel to the upper surface of the substrate W. Thus, the first water nozzle 13A functions as a water stream forming mechanism for forming a stream of the deionized water (a water stream) on the upper surface of the substrate W. The second water nozzle 13B is provided in the form of a straight nozzle which supplies the deionized water toward the center portion of the substrate W.

The substrate drying unit 3 is disposed above the substrate holding mechanism 1. The substrate drying unit 3 includes a disk-shaped plate heater (e.g., a ceramic heater) 35 having substantially the same diameter as the substrate W. The plate heater 35 is held generally horizontally by a support cylinder 36 which is moved up and down by a lift mechanism 34. Further, a disk-shaped thin filter plate 37 having substantially the same diameter as the plate heater 35 is disposed generally horizontally (i.e., generally parallel to the plate heater 35) below the plate heater 35. The filter plate 37 is composed of quartz glass. The disk-shaped heater 35 emits infrared radiation toward the upper surface of the substrate W through the filter plate 37 of the quartz glass.

A first nitrogen gas supply path 38 is provided inside the support cylinder 36 for supplying nitrogen gas as a cooling gas toward the center portion of the upper surface of the substrate W. The temperature of the nitrogen gas is controlled at about a room temperature (about 21 to about 23° C.). The nitrogen gas supplied from the first nitrogen gas supply path 38 is supplied into a space defined between the upper surface of the substrate W and a lower surface (substrate opposing surface) of the filter plate 37. The nitrogen gas is supplied to the first nitrogen gas supply path 38 via a nitrogen gas valve 39.

A second nitrogen gas supply path 40 is provided around the first nitrogen gas supply path 38 for supplying nitrogen gas as a cooling gas into a space defined between an upper surface of the filter plate 37 and a lower surface of the plate heater 35. The temperature of the nitrogen gas is controlled at about a room temperature (about 21 to about 23° C.). The nitrogen gas supplied from the second nitrogen gas supply path 40 is supplied into the space between the upper surface of the filter plate 37 and the lower surface of the plate heater 35. The nitrogen gas is supplied into the second nitrogen gas supply path 40 via a nitrogen gas valve 41.

When the substrate W on the substrate holding mechanism 1 is to be dried, the plate heater 35 is energized with the nitrogen gas valves 39, 41 being opened, and the substrate opposing surface (lower surface) of the filter plate 37 is brought into proximity to the surface of the substrate W (e.g., to a distance of about 1 mm from the surface of the substrate W). Thus, water present on the surface of the substrate W is evaporated by the infrared radiation passing through the filter plate 37.

The filter plate 37 of the quartz glass is capable of absorbing a predetermined infrared wavelength region. Of the infrared radiation emitted from the plate heater 35, the predetermined infrared wavelength region for which the quartz glass is absorptive is blocked by the filter plate 37 and, hence, hardly reach the substrate W. Therefore, the substrate W is irradiated selectively with an infrared wavelength region for which the filter plate 37 or the quartz glass is transmissive. More specifically, the plate heater 35 (infrared ceramic heater) is adapted to emit infrared radiation in a wavelength range of about 3 to about 20 μm. A 5-mm thick quartz glass plate, for example, is absorptive of infrared wavelengths not less than 4 μm. Therefore, where the infrared ceramic heater and the quartz glass plate are used in combination, the substrate W is irradiated selectively with infrared radiation in a wavelength range greater than about 3 μm and less than 4 μm.

On the other hand, water significantly absorbs infrared radiation at wavelengths of 3 μm and 6 μm. The energy of the infrared radiation absorbed by the water vibrates water molecules, which in turn generate frictional heat. That is, the water can be efficiently heated to be evaporated by irradiation with infrared radiation having a wavelength for which the water is absorptive. Therefore, when the substrate W is irradiated with infrared radiation having a wavelength of about 3 μm, water droplets adhering to the substrate W absorb the infrared radiation to be heated and evaporated, whereby the substrate W is dried.

Where the substrate W is a silicon substrate, the substrate W is absorptive of infrared wavelengths greater than 7 μm and transmissive of infrared wavelengths smaller than 7 μm, so that the substrate W is hardly heated by the irradiation with the infrared radiation having a wavelength of 3 μm. Of the infrared radiation emitted from the infrared ceramic heater, an infrared wavelength region for which the water is absorptive and the substrate W is transmissive is applied to the substrate W, whereby the water droplets adhering to the substrate W are efficiently heated and evaporated to dry the substrate W without heating the substrate W. The material for the filter plate 37 is not limited to the quartz glass, but may be any material which is transmissive of the infrared wavelengths absorbable by the water and absorptive of the infrared wavelengths absorbable by the substrate W.

When the plate heater (ceramic heater) 35 is energized, the heat is likely to be transmitted from the plate heater 35 to the substrate W by heat convection, but is blocked by the filter plate 37. However, the temperature of the space defined between the lower surface of the plate heater 35 and the upper surface of the filter plate 37 is increased by the heat convection, thereby gradually heating the filter plate 37. Therefore, the substrate W is liable to be heated by heat transmitted from the filter plate 37 to the substrate W by heat convection. To cope with this, the temperature rise in the space between the lower surface of the plate heater 35 and the upper surface of the filter plate 37 is suppressed by supplying the nitrogen gas as the cooling gas into the space. Further, the temperature rise of the filter plate 37 due to the absorption of the infrared radiation from the plate heater 35 is also suppressed by the supply of the nitrogen gas to the space between the plate heater 35 and the filter plate 37. Thus, the heating of the substrate W due to the heat convection from the filter plate 37 is also prevented.

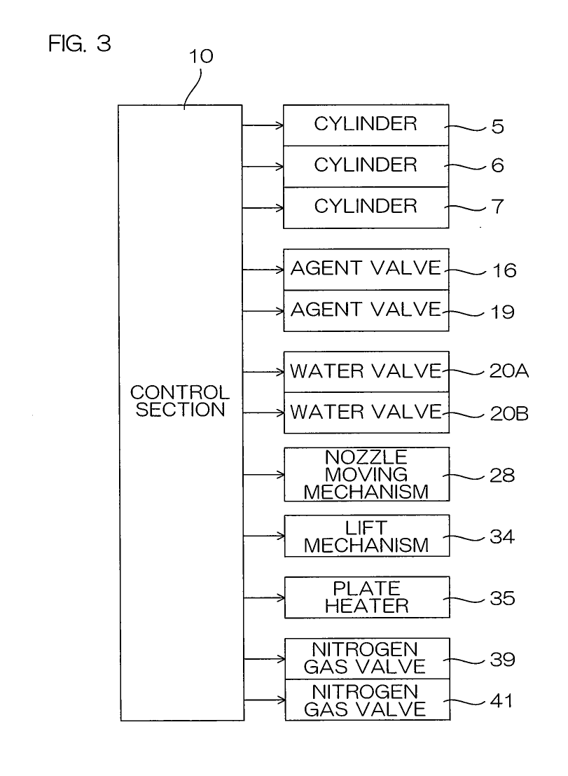

FIG. 3 is a block diagram for explaining an arrangement for controlling the substrate treatment apparatus. The substrate treatment apparatus includes a control section 10 including a computer and the like. The control section 10 controls the operations of the cylinders 5, 6, 7, the opening and closing of the agent valves 16, 19 and the water valves 20A, 20B, the operation of the nozzle moving mechanism 28, the operation of the lift mechanism 34, the energization of the plate heater 35, and the opening and closing of the nitrogen gas valves 39, 40.

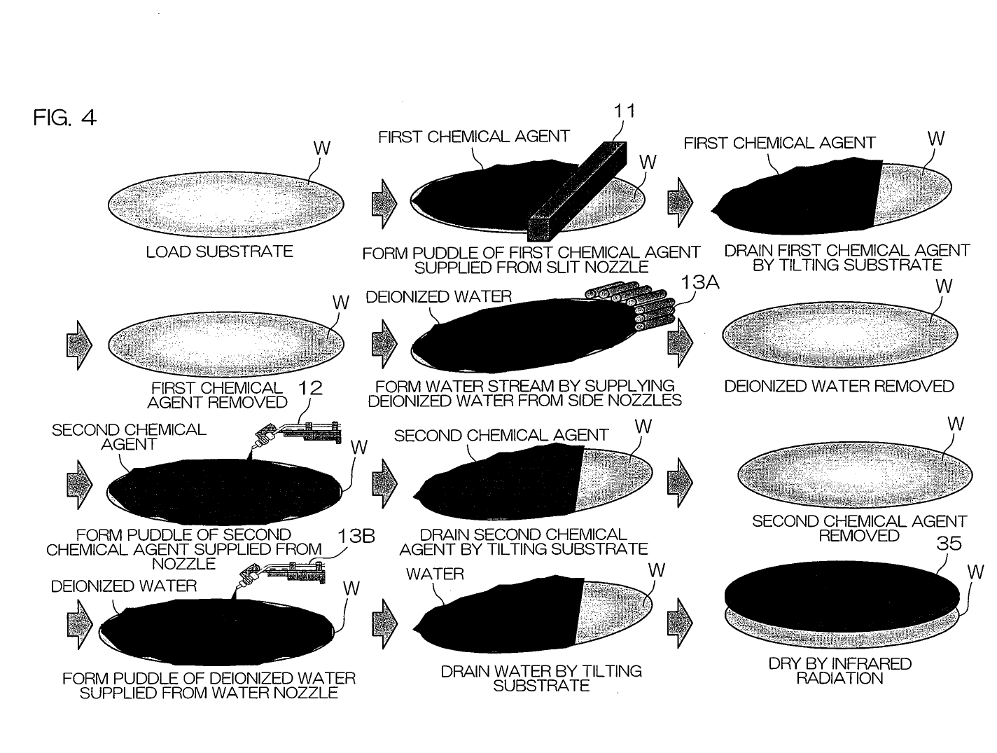

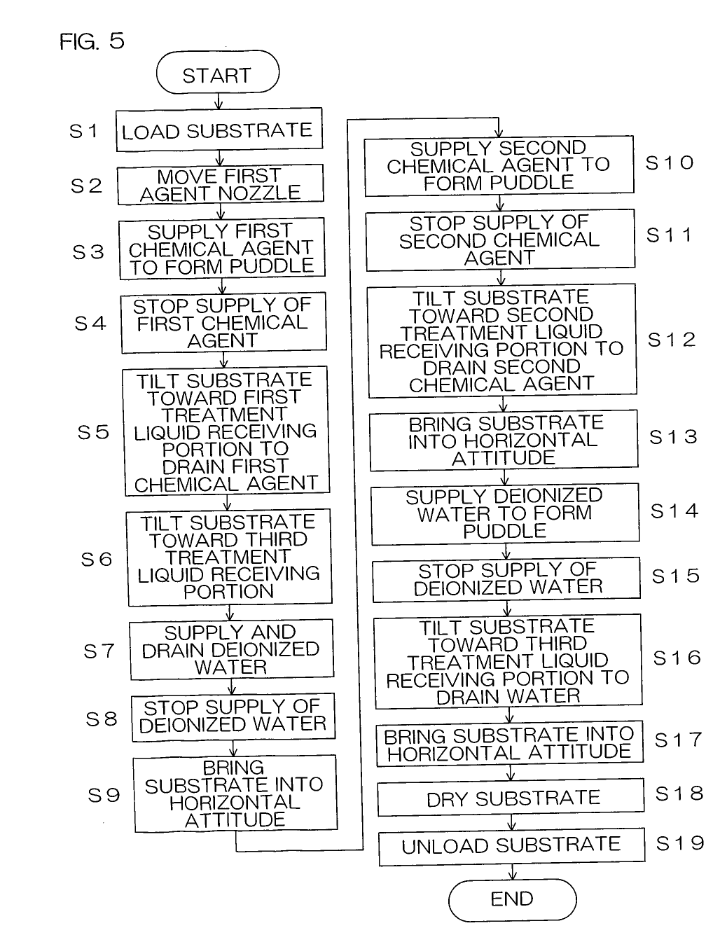

FIG. 4 is a schematic diagram for explaining an exemplary process sequence for treatment of the substrate W. FIG. 5 is a flow chart for explaining operations to be performed by the substrate treatment apparatus according to the process sequence. A substrate cleaning process will be herein explained by way of example, in which the surface of the substrate W is treated with sulfuric acid as the first chemical agent, rinsed with the water, treated with an ammonia/hydrogen peroxide solution mixture as the second chemical agent, rinsed with water, and dried.

An untreated substrate W is loaded into the substrate treatment apparatus by a substrate transport robot not shown, and transferred onto the support pins 31, 32, 33 of the substrate holding mechanism 1 (Step S1). At this time, the support pins 31, 32, 33 are set at the same substrate support level to hold the substrate W in the horizontal attitude. In this state, the control section 10 controls the nozzle moving mechanism 28 to move the first agent nozzle 11 along the upper surface of the substrate W (Step S2). At the same time, the control section 10 opens the agent valve 16 to supply the sulfuric acid as the first chemical agent from the first agent nozzle 11. Thus, a puddle of the sulfuric acid is formed on the upper surface of the substrate W, as the first agent nozzle 11 is moved (Step S3). When the sulfuric acid is spread over the entire upper surface of the substrate W, the control section 10 closes the agent valve 16 to stop the supply of the sulfuric acid (Step S4).

Although the sulfuric acid has a relatively high viscosity, the sulfuric acid puddle can be evenly formed on the entire upper surface of the substrate W by scanning the upper surface of the substrate W with the first agent nozzle 11 having the slit nozzle form.

After the sulfuric acid puddle is retained on the upper surface of the substrate W for a predetermined period, the control section 10 drives the cylinder 5 to move up the support pin 31 to a higher substrate support level. At this time, the substrate support levels of the support pins 32, 33 are kept unchanged. Thus, the substrate W is brought into the tilted attitude to be tilted down toward the first treatment liquid receiving portion 21, so that the sulfuric acid present on the upper surface of the substrate W flows down toward the first treatment liquid receiving portion 21 to be received in the first treatment liquid receiving portion 21 (Step S5). The sulfuric acid received in the first treatment liquid receiving portion 21 is recovered in the first agent tank 14 via the agent recovery pipe 25.

In turn, the control section 10 drives the cylinder 5 to move the support pin 31 back to the original substrate support level, and drives the cylinder 7 to move up the support pin 33 to a higher substrate support level. At this time, the substrate support level of the support pin 32 is kept unchanged. Thus, the substrate W is brought into the tilted attitude to be tilted down toward the third treatment liquid receiving portion 23 (Step S6). In this state, the control section 10 opens the water valve 20A to supply the deionized water onto the upper surface of the substrate W from the first water nozzle 13A from the lateral side. Thus, the water flows from the first water nozzle 13A toward the third treatment liquid receiving portion 23 to form a water stream over the substrate W (Step S7). The water flows down from the substrate W into the third treatment liquid receiving portion 23, and is drained through the drain pipe 27. Thus, sulfuric acid remaining on the substrate W is washed away by the water stream.

After the upper surface of the substrate W is thus subjected to the water stream for a predetermined period, the control section 10 closes the water valve 20A to stop the supply of the deionized water (Step S8). Thereafter, the control section 10 drives the cylinder 7 to move the support pin 33 back to the original substrate support level. Thus, the substrate W is brought into the horizontal attitude (Step S9).

Subsequently, the control section 10 opens the agent valve 19 to supply the ammonia/hydrogen peroxide solution mixture as the second chemical agent from the second agent nozzle 12 toward the center of the substrate W (Step S10). At this time, the flow rate of the chemical agent is such that the chemical agent supplied onto the upper surface of the substrate W can be kept in a puddle form. Thus, a puddle of the ammonia/hydrogen peroxide solution mixture (second chemical agent) is formed on the upper surface of the substrate W. The ammonia/hydrogen peroxide solution mixture has a relatively low viscosity and, therefore, is easily spread over the entire surface of the substrate W by supplying the solution mixture from the second agent nozzle 12 having the straight nozzle form. When the ammonia/hydrogen peroxide solution mixture is spread over the entire surface of the substrate W, the control section 10 closes the agent valve 19 to stop the supply of the ammonia/hydrogen peroxide solution mixture (Step S11). Then, the puddle of the ammonia/hydrogen peroxide solution mixture is kept on the upper surface of the substrate W held in the horizontal attitude for a predetermined period. As long as the substrate W is held in the horizontal attitude, the puddle of the ammonia/hydrogen peroxide solution mixture can be retained on the upper surface of the substrate W by surface tension.

Thereafter, the control section 10 drives the cylinder 6 to move up the support pin 32 to a higher substrate support level. At this time, the substrate support levels of the support pins 31, 33 are kept unchanged. As a result, the substrate W is brought into the tilted attitude to be tilted down toward the second treatment liquid receiving portion 22. Thus, the ammonia/hydrogen peroxide solution mixture present in the puddle form on the upper surface of the substrate W flows down toward the second treatment liquid receiving portion 22 to be received in the second treatment liquid receiving portion 22 (Step S12). The received ammonia/hydrogen peroxide solution mixture is recovered in the second agent tank 17 via the agent recovery pipe 26.

After the substrate W is kept in the tilted attitude for a predetermined period, the control section 10 drives the cylinder 6 to move the support pin 32 back to the original substrate support level. Thus, the substrate W is brought into the horizontal attitude (Step S13). In this state, the control section 10 opens the water valve 20B to supply the deionized water from the second water nozzle 13B toward the center of the substrate W (Step S14). At this time, the flow rate of the deionized water is such that the water can be kept in a puddle form on the surface of the substrate W held in the horizontal attitude. When a water puddle is thus formed on the upper surface of the substrate W to cover the entire upper surface of the substrate W, the control section 10 closes the water valve 20B (Step S15). As long as the substrate W is held in the horizontal attitude, the water puddle can be retained on the substrate W by surface tension.

After the water puddle is retained on the surface of the substrate W for a predetermined period, the control section 10 drives the cylinder 7 to move up the support pin 33 to a higher substrate support level. At this time, the substrate support levels of the support pins 31, 32 are kept unchanged. As a result, the substrate W is brought into the tilted attitude to be tilted down toward the third treatment liquid receiving portion 23. Thus, the water present in the puddle form on the surface of the substrate W flows down toward the third treatment liquid receiving portion 23 to be received in the third treatment liquid receiving portion 23 and drained via the drain pipe 27 (Step S16).

After the substrate W is kept in the tilted attitude for a predetermined period, the control section 10 drives the cylinder 7 to move the support pin 33 back to the original substrate support level. Thus, the substrate W is brought back into the horizontal attitude (Step S17).

Subsequently, the control section 10 controls the lift mechanism 34 to move down the plate heater 35 to a predetermined treatment position at which the substrate opposing surface (lower surface) of the filter plate 37 is in close proximity to the upper surface of the substrate W at a predetermined distance (e.g., 1 mm) from the upper surface of the substrate W. Prior to this, the agent nozzles 11, 12 and the water nozzles 13A, 13B are retracted outside the substrate W. In this state, the control section 10 energizes the plate heater 35. Thus, water droplets remaining on the substrate W after the water is drained by tilting the substrate W are evaporated by the infrared radiation transmitted through the filter plate 37 to reach the surface of the substrate W. Further, the control section 10 opens the nitrogen gas valves 39, 41 to supply the nitrogen gas to the first and second nitrogen gas supply paths 38, 40. Thus, the nitrogen gas (cooling gas) controlled at the room temperature is supplied into the space between the substrate W and the filter plate 37 and the space between the filter plate 37 and the plate heater 35. This makes it possible to maintain the upper surface of the substrate W in the nitrogen gas atmosphere, while suppressing the heat transmission from the plate heater 35 and the filter plate 37 to the substrate W. Thus, the water droplets remaining on the upper surface of the substrate W absorb the infrared radiation to be evaporated, whereby the substrate W is dried (Step S18).

After the drying of the substrate W, the treated substrate W is unloaded from the apparatus by the substrate transport robot (Step S19).

Thus, the treatment of the single substrate W is completed. Where another substrate is to be treated, the aforesaid treatment process is repeated.

According to this embodiment, as described above, the three support pins 31, 32, 33 of the substrate holding mechanism 1 are moved up and down by the cylinders 5, 6, 7 to tilt the substrate W supported on the support pins 31, 32, 33 in the three directions. Since the first, second and third treatment liquid receiving portions 21, 22, 23 are disposed in association with the respective tilt directions, the treatment liquids are separately drained in the three directions from the substrate W. Thus, the first chemical agent, the second chemical agent and the water can be separately drained, and the first chemical agent and the second chemical agent can be separately recovered for reuse.

In this embodiment, the substrate holding mechanism 1 is not adapted to rotate the substrate W, but adapted to hold the substrate in the horizontal attitude or in the tilted attitude when the treatment liquid is supplied to the substrate W. That is, the substrate W held in the non-rotative state is surface-treated with any of the treatment liquids by covering the upper surface of the substrate W with a film of the treatment liquid. Therefore, the treatment liquid is unlikely to be splashed outside the substrate W. This obviates the need for the provision of the guard which may otherwise be required for receiving the scattered treatment liquid in the prior art, thereby simplifying the construction of the substrate treatment apparatus and reducing the costs of the apparatus. Since the diffusion of treatment liquid droplets in the apparatus is significantly suppressed as compared with the prior art apparatus, it is possible to suppress or prevent the problem associated with the diffusion of the adhering chemical agents in the atmosphere. Further, the quality of the substrate treatment is improved without the possibility that the liquid droplets scattered outside the substrate W at a high speed are splashed back by the guard to adhere again onto the substrate W.

In addition, there is no need to provide a motor for the rotation of the substrate without the need for the high speed rotation of the substrate W. This eliminates the need for the measures against dust generation around the motor, thereby further reducing the production costs of the substrate treatment apparatus.

Without the need for the provision of the guard and the motor, there is no need to provide a large space around the substrate holding mechanism 1. Therefore, it is possible to perform the treatment of the substrate W in a smaller space, so that the size of the substrate treatment apparatus can be significantly reduced. In other words, provided that the substrate treatment apparatus has substantially the same size as the prior art apparatus, a greater number of substrate treatment units can be provided in the substrate treatment apparatus. More specifically, the same or different types of substrate treatment units can be provided in a vertically stacked relation in the apparatus.

Further, the substrate W is treated with the first and second chemical agents by forming the puddles of the first and second chemical agents on the substrate W, so that the amounts of the chemical agents to be used for the substrate treatment can be reduced as compared with the prior art apparatus. Thus, the running costs can be reduced. Since the second chemical agent (ammonia/hydrogen peroxide solution mixture) is rinsed away by forming the puddle of the deionized water, the amount of the deionized water to be used for the substrate treatment is reduced, thereby correspondingly reducing the running costs of the apparatus.

In the prior art apparatus adapted to dry the substrate W by the high speed rotation of the substrate W, water marks are liable to be formed due to water droplets radially scattered by the high speed rotation. In this embodiment, however, the substrate W held in the non-rotative state is dried by the infrared radiation. Therefore, the formation of the water marks is suppressed or prevented.

Without the need for the high speed rotation of the substrate W, there is no need to provide a support member for firmly supporting the substrate W. Therefore, the substrate W is free from a great load which may otherwise be applied by the support member, so that chipping and other defects of the substrate W are suppressed or prevented.

In the prior art apparatus adapted to rotate the substrate W at a high speed, electrostatic charges are inevitably generated due to friction occurring between the substrate surface and the chemical agent or air. In this embodiment, however, the treatment of the substrate W is basically performed with the substrate W being kept in the non-rotative state, so that the problem associated with the electrostatic charges generated due to the friction can be suppressed or prevented.

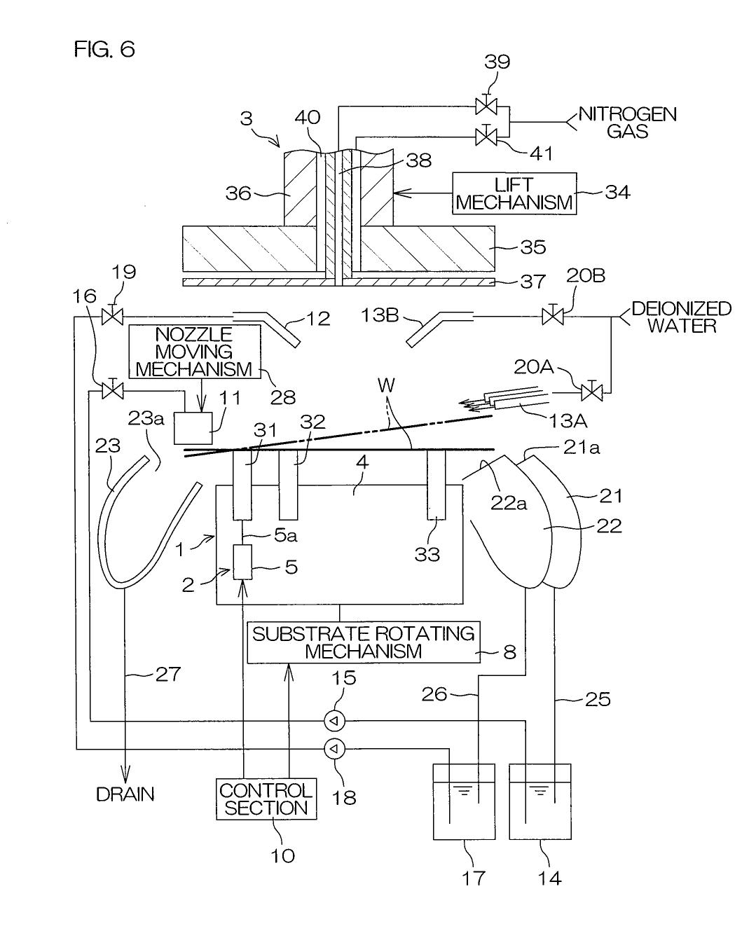

FIG. 6 is a schematic sectional view for explaining the construction of a substrate treatment apparatus according to a second embodiment of the present invention. In FIG. 6, components corresponding to those shown in FIGS. 1 to 5 will be denoted by the same reference characters as described above.

In this embodiment, a single cylinder 5 is provided for one support pin 31 of the three support pins 31, 32, 33, and the other two support pins 32, 33 are fixed to the base 4 with their substrate support levels being kept constant.

A substrate rotating mechanism 8 is provided for rotating the base 4 about a vertical rotation axis extending through the center portion of the substrate W. The substrate rotating mechanism 8 is adapted to rotate the substrate W at a low speed to change the angular position of the substrate W, but is not required to rotate the base 4 at a high speed such as to spin off the treatment liquid from the upper surface of the substrate W.

When the treatment liquid is to be drained from the substrate W into the first treatment liquid receiving portion 21, the control section 10 controls the substrate rotating mechanism 8 to rotate the base 4 to move the vertically movable support pin 31 to a position opposed to the first treatment liquid receiving portion 21 with the center of the substrate W being located therebetween. In this state, the control section 10 drives the cylinder 5 to move up the support pin 31 to a higher substrate support level. Thus, the substrate W is brought into the tilted attitude to be tilted down toward the first treatment liquid receiving portion 21. Similarly, when the treatment liquid is to be drained from the substrate W into the second treatment liquid receiving portion 22, the control section 10 controls the substrate rotating mechanism 8 to rotate the base 4 to move the support pin 31 to a position opposed to the second treatment liquid receiving portion 22 with the center of the substrate W being located therebetween. In this state, the control section 10 drives the cylinder 5 to move up the support pin 31 to a higher substrate support level. Thus, the substrate W is brought into the tilted attitude to be tilted down toward the second treatment liquid receiving portion 22. Further, when the treatment liquid is to be drained from the substrate W into the third treatment liquid receiving portion 23, the control section 10 controls the substrate rotating mechanism 8 to rotate the base 4 to move the support pin 31 to a position opposed to the third treatment liquid receiving portion 23 with the center of the substrate W being located therebetween. In this state, the control section 10 drives the cylinder 5 to move up the support pin 31 to a higher substrate support level. Thus, the substrate W is brought into the tilted attitude to be tilted down toward the third treatment liquid receiving portion 23.

With this arrangement, one of the first to third treatment liquid receiving portions 21, 22, 23 arranged along the outer periphery of the substrate W held by the substrate holding mechanism 1 is selected, and the treatment liquid is drained from the substrate W into the selected treatment liquid receiving portion. Thus, the treatment liquids are separately drained according to types thereof into the corresponding treatment liquid receiving portions 21, 22, 23 from the substrate W, so that the recovery rates of the treatment liquids are improved as in the first embodiment. The drainage of the treatment liquid from the substrate W can be achieved without the high-speed rotation of the substrate W, thereby obviating the need for the provision of the guard which may otherwise be required in the prior art. Further, this embodiment provides the same effects as described in relation to the first embodiment.

In this embodiment, the substrate rotating mechanism 8 is provided for rotating the base 4. However, the substrate rotating mechanism 8 is merely adapted to change the angular position of the single vertically movable support pin 31, but is not required to rotate the base 4 at a high speed such as to spin off the treatment liquid from the substrate W by a centrifugal force. Therefore, it is sufficient to provide a small-size rotation mechanism such as a small-size motor, which does not occupy a large space in the substrate treatment apparatus.

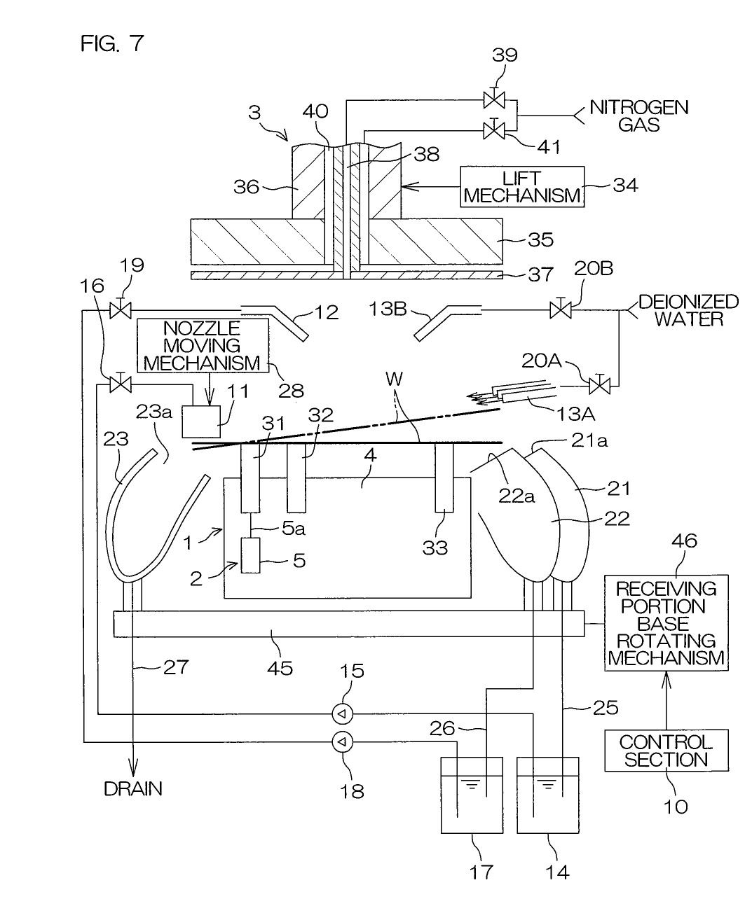

FIG. 7 is a schematic sectional view for explaining the construction of a substrate treatment apparatus according to a third embodiment of the present invention. In FIG. 7, components corresponding to those shown in FIGS. 1 to 5 will be denoted by the same reference characters as described above.

In this embodiment, a single cylinder 5 is provided for one support pin 31 of the three support pins 31, 32, 33 as in the second embodiment, and the other two support pins 32, 33 are fixed to the base 4 with their substrate support levels being kept constant.

On the other hand, the first to third treatment liquid receiving potions 21, 22, 23 are retained by a receiving portion base 45 which is rotatable about a vertical axis extending through the center portion of the substrate W held by the substrate holding mechanism 1. The receiving portion base 45 is rotatively driven by a receiving portion base rotating mechanism 46.

When the treatment liquid is to be drained from the substrate W into the first treatment liquid receiving portion 21, the control section 10 controls the receiving portion base rotating mechanism 46 to rotate the receiving portion base 45 to move the first treatment liquid receiving portion 21 to a position opposed to the vertically movable support pin 31 with the center of the wafer W being located therebetween. In this state, the control section 10 drives the cylinder 5 to move up the support pin 31. Thus, the substrate W is brought into the tilted attitude to be tilted down toward the first treatment liquid receiving portion 21. Similarly, when the treatment liquid is to be drained from the substrate W into the second treatment liquid receiving portion 22, the control section 10 controls the receiving portion base rotating mechanism 46 to rotate the receiving portion base 45 to move the second treatment liquid receiving portion 22 to the position opposed to the support pin 31 with the center of the substrate W being located therebetween. In this state, the control section 10 drives the cylinder 5 to move up the support pin 31. Thus, the substrate W is brought into the tilted attitude to be tilted down toward the second treatment liquid receiving portion 22. Further, when the treatment liquid is to be drained from the substrate W into the third treatment liquid receiving portion 23, the control section 10 controls the receiving portion base rotating mechanism 46 to rotate the receiving portion base 45 to move the third treatment liquid receiving portion 23 to the position opposed to the support pin 31 with the center of the substrate W being located therebetween. In this state, the control section 10 drives the cylinder 5 to move up the support pin 31. Thus, the substrate W is brought into the tilted attitude to be tilted down toward the third treatment liquid receiving portion 23.

With this arrangement, one of the first to third treatment liquid receiving portions 21, 22, 23 arranged along the outer periphery of the substrate W held by the substrate holding mechanism 1 is selected, and the treatment liquid is drained from the substrate W into the selected treatment liquid receiving portion. Thus, the treatment liquids are separately drained according to types thereof into the corresponding treatment liquid receiving portions 21, 22, 23 from the substrate W, so that the recovery rates of the treatment liquids can be improved as in the first and second embodiments. The drainage of the treatment liquid from the substrate W can be achieved without the high speed rotation of the substrate W, thereby obviating the need for the provision of the guard which may otherwise be required in the prior art. Further, this embodiment provides the same effects as described in relation to the first embodiment.

In this embodiment, the receiving portion base rotating mechanism 46 is provided for rotating the receiving portion base 45. However, the receiving portion base rotating mechanism 46 is merely adapted to unitarily change the angular positions of the first to third treatment liquid receiving portions 21, 22, 23, but is not required to rotate the receiving portion base 45 at a high speed such as to spin off the treatment liquid from the substrate W by a centrifugal force. Therefore, a small-size rotation mechanism such as a small-size motor sufficiently functions as the receiving portion base rotating mechanism 46 as in the case of the substrate rotating mechanism 8 in the second embodiment. Such a rotation mechanism does not occupy a large space in the substrate treatment apparatus.

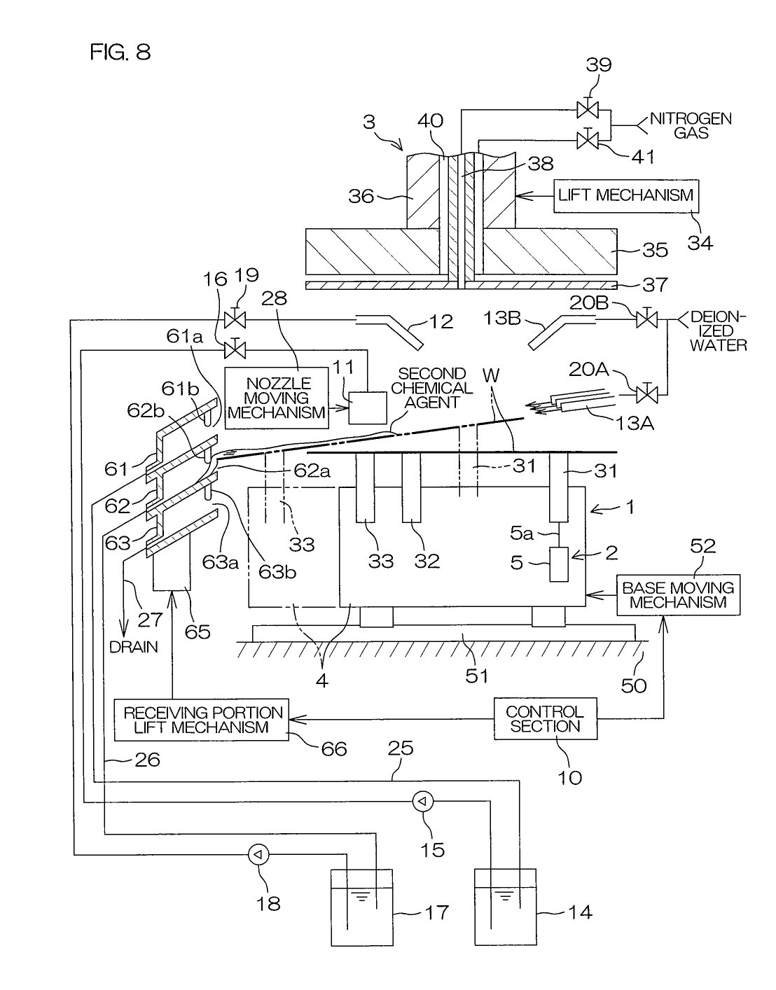

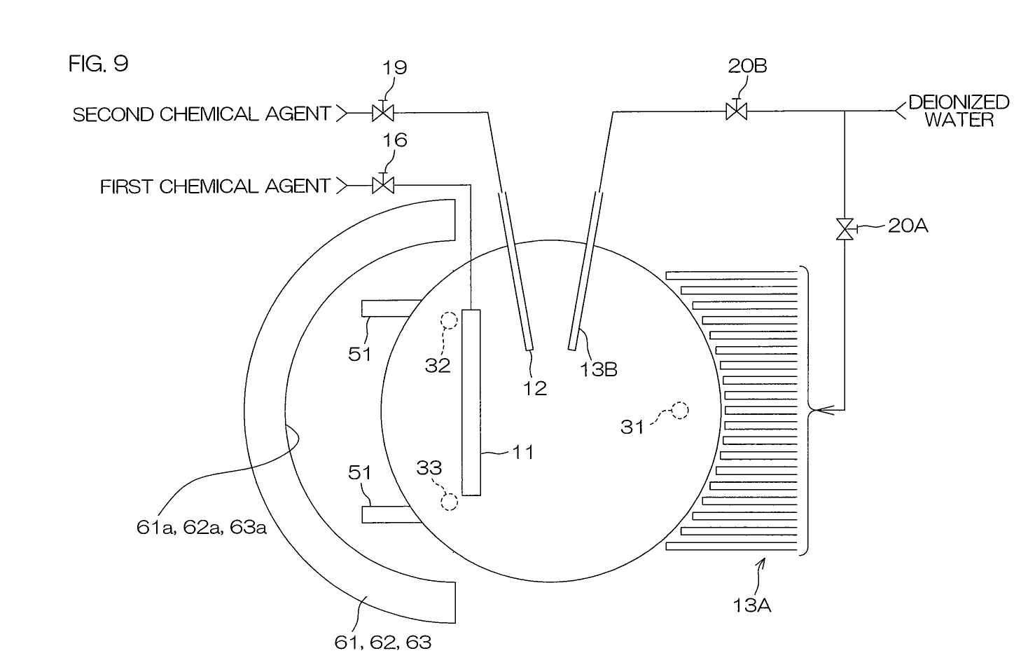

FIG. 8 is a schematic sectional view for explaining the construction of a substrate treatment apparatus according to a fourth embodiment of the present invention. FIG. 9 is a schematic plan view of the substrate treatment apparatus. In FIGS. 8 and 9, components corresponding to those shown in FIGS. 1 to 5 will be denoted by the same reference characters as described above.

In this embodiment, the substrate holding mechanism 1 is horizontally linearly movable along rails 51 fixed to a frame 50 of the substrate treatment apparatus. A base moving mechanism 52 is provided for moving the base 4 along the rails 51. First to third treatment liquid receiving portions 61, 62, 63 are vertically stacked at one end of a movable range of the base 4. The first to third treatment liquid receiving portions 61, 62, 63 are unitarily supported by a support portion 65. Further, a receiving portion lift mechanism 66 for moving up and down the first to third treatment liquid receiving portions 61, 62, 63 is connected to the support portion 65.

The first treatment liquid receiving portion 61 is located at the uppermost position, and adapted to receive the first chemical agent supplied from the first agent nozzle 11. The chemical agent received in the first treatment liquid receiving portion 61 is recovered in the first agent tank 14 via the agent recovery pipe 25 for reuse.

The second treatment liquid receiving portion 62 is located at the middle position, and adapted to receive the second chemical agent supplied from the second agent nozzle 12. The chemical agent received in the second treatment liquid receiving portion 62 is recovered in the second agent tank 17 via the agent recovery pipe 26 for reuse.

The third treatment liquid receiving portion 63 is located at the lowermost position, and adapted to receive the deionized water supplied from the first and second water nozzles 13A, 13B. The water received in the third treatment liquid receiving portion 63 is drained into the drain pipe 27.

In this embodiment, one support pin 31 of the three support pins 31, 32, 33 provided on the base 4 is adapted to be moved up and down by the cylinder 5, and the other two support pins 32, 33 are fixed to the base 4 with their substrate support levels being kept constant. More specifically, the vertically movable support pin 31 is disposed at a position opposed to the first to third treatment liquid receiving portions 61, 62, 63 with the center of the substrate W being located therebetween. The other two support pins 32, 33 are located closer to the first to third treatment liquid receiving portions 61, 62, 63 than the center of the substrate W. The base 4 is slidable on the rails 51 in a non-rotative state.

As shown in the plan view of FIG. 9, the first to third treatment liquid receiving portions 61, 62, 63 respectively have arcuate drain ports 61a, 62a, 63a extending across an about 180-degree angular range along the outer periphery of the substrate W.

With this arrangement, the base moving mechanism 52 is driven to move the substrate holding mechanism 1 between a treatment position (indicated by a solid line in FIG. 8) spaced from the first to third treatment liquid receiving portions 61, 62, 63 and a liquid drain position (indicated by a two-dot-and-dash line in FIG. 8) proximate to the first to third treatment liquid receiving portions 61, 62, 63. By driving the cylinder 5 to move up the support pin 31, the substrate W is brought into the tilted attitude to be tilted down toward the first to third treatment liquid receiving portions 61, 62, 63. With the support pin 31 being located at a lower portion, the substrate W is in the generally horizontal attitude.

On the other hand, the first to third treatment liquid receiving portions 61, 62, 63 are unitarily moved up and down by controlling the receiving portion lift mechanism 66. Thus, one of the drain ports 61a, 62a, 63a of the first to third treatment liquid receiving portions 61, 62, 63 is brought into opposed relation to an edge of the substrate W held by the substrate holding mechanism 1.

When a puddle of the first or second chemical agent is to be formed for the substrate treatment by supplying the chemical agent onto the substrate W from the first agent nozzle 11 or the second agent nozzle 12, the substrate holding mechanism 1 is located at the treatment position spaced from the first to third treatment liquid receiving portions 61, 62, 63, and the support pin 31 is located at the lower position. Thus, the substrate W is held in the horizontal attitude in spaced relation from the first to third treatment liquid receiving portions 61, 62, 63. When a puddle of the deionized water is to be formed by supplying the water onto the substrate W from the second water nozzle 13B and when the substrate W is dried by the substrate drying unit 3, the control for positioning the substrate holding mechanism 1 is performed in the same manner as described above.

On the other hand, when the puddle of the first chemical agent formed on the substrate W is to be removed from the substrate W, the control section 10 controls the receiving portion lift mechanism 66 to bring the first treatment liquid receiving portion 61 into opposed relation to the edge of the substrate W. Further, the control section 10 controls the base moving mechanism 52 to move the substrate holding mechanism 1 to the liquid drain position. Then, the control section 10 drives the cylinder 5 to move up the support pin 31. Thus, the substrate W is brought into the tilted attitude to be tilted down toward the first treatment liquid receiving portion 61 with the edge thereof being opposed to the first treatment liquid receiving portion 61. As a result, the first chemical agent is drained from the substrate W and received in the first treatment liquid receiving portion 61.

When the puddle of the second chemical agent formed on the substrate W is to be removed from the substrate W, the control section 10 controls the receiving portion lift mechanism 66 to bring the second treatment liquid receiving portion 62 into opposed relation to the edge of the substrate W. Further, the control section 10 controls the base moving mechanism 52 to move the substrate holding mechanism 1 to the liquid drain position. In this state, the control section 10 drives the cylinder to move up the support pin 31. As a result, the substrate W is brought into the tilted attitude to be tilted down toward the second treatment liquid receiving portion 62 with a lower edge portion thereof being opposed to the second treatment liquid receiving portion 62. Thus, the second chemical agent is drained from the substrate W and received in the second treatment liquid receiving portion 62.

When the water puddle formed on the substrate W by supplying the deionized water from the second water nozzle 13B is to be removed from the substrate W, the control section 10 controls the receiving portion lift mechanism 66 to bring the third treatment liquid receiving portion 63 into opposed relation to the edge of the substrate W. Further, the control section 10 controls the base moving mechanism 52 to move the substrate holding mechanism 1 to the liquid drain position. In this state, the control section 10 drives the cylinder 5 to move up the support pin 31. Thus, the substrate W is brought into the tilted attitude to be tilted down toward the third treatment liquid receiving portion 63 with the lower edge portion thereof being opposed to the third treatment liquid receiving portion 63. As a result, the water is drained from the substrate W and received in the third treatment liquid receiving portion 63.

When a water stream is to be formed on the substrate W by supplying the deionized water onto the substrate W from the first water nozzle 13A, the control section 10 controls the receiving portion lift mechanism 66, the base moving mechanism 52 and the cylinder 5 in the same manner as described above. In this state, the control section 10 opens the water valve 20A to supply the deionized water from the first water nozzle 13A toward the substrate W held in the tilted attitude. Thus, the water stream is formed on the substrate W held in the tilted attitude, and flows down from the lower edge portion of the substrate W to be received in the third treatment liquid receiving portion 63.

Guide members (guide pins) 61b, 62b, 63b are respectively provided in the drain ports 61a, 62a, 63a of the first to third treatment liquid receiving portions 61, 62, 63 for guiding the treatment liquids from the substrate W into the first to third treatment liquid receiving portions 61, 62, 63. The guide members 61b, 62b, 63b respectively project vertically downward from ceilings of the first to third treatment liquid receiving portions 61, 62, 63. The guide members 61b, 62b, 63b are each brought into contact with the treatment liquid on the substrate W at the lower edge portion of the substrate W held in the tilted attitude to guide the treatment liquid into the corresponding treatment liquid receiving portion 61, 62, 63 so as to prevent the treatment liquid from flowing behind the substrate W. Thus, the treatment liquids can be efficiently guided into the corresponding treatment liquid receiving portions 61, 62, 63, whereby the amounts of the treatment liquids flowing outside the first to third treatment liquid receiving portions 61, 62, 63 are minimized. This improves the recovery rates of the chemical agents, and suppresses contamination of the inside of the substrate treatment apparatus.

Even if the substrate W is held in the tilted attitude, the puddle of the treatment liquid on the substrate W is liable to remain on the upper surface of the substrate W by surface tension. In this state, a corresponding one of the guide members 61b, 62b, 63b is brought into contact with the treatment liquid puddle, whereby the surface tension is reduced to disintegrate the treatment liquid puddle. Thus, the treatment liquid quickly flows down from the substrate W.

The guide members 61b, 62b, 63b are preferably each arranged to be brought into contact with the treatment liquid on the substrate W without contact with the substrate W. More specifically, positional relationships between the liquid drain position of the substrate holding mechanism 1 and the guide members 61b, 62b, 63b are preferably defined so that the guide members 61b, 62b, 63b are each brought into contact with the treatment liquid on the substrate W without direct contact with the substrate W. This suppresses or prevents the contamination and breakage of the substrate W which may otherwise occur due to the contact of the substrate W with the guide members 61b, 62b, 63b.

In this embodiment, as described above, the treatment liquids are separately drained accordingly to types thereof into the corresponding treatment liquid receiving portions 61, 62, 63 from the substrate W by holding the substrate W in the tilted attitude without rotating the substrate W.

In this embodiment, one of the first to third treatment liquid receiving portions 61, 62, 63 is brought into opposed relation to the edge of the substrate W by unitarily moving up and down the first to third treatment liquid receiving portions 61, 62, 63 by the receiving portion lift mechanism 66. Alternatively, the first to third treatment liquid receiving portions 61, 62, 63 may be each disposed at a fixed level, and a substrate level changing mechanism may be provided for changing the level of the substrate W supported by the substrate holding mechanism 1. The substrate level changing mechanism may be adapted to move up and down the base 4 with respect to the frame 50, or adapted to evenly move up and down the support pins 31, 32, 33 with respect to the base 4. Further, the substrate treatment apparatus may be arranged such that the first to third treatment liquid receiving portions 61, 62, 63 are vertically movable and the level of the substrate is changeable.

In this embodiment, the substrate holding mechanism 1 is moved toward and away from the treatment liquid receiving portions 61, 62, 63 by the base moving mechanism 52. Alternatively, the substrate holding mechanism 1 may be located at a fixed horizontal position, and a treatment liquid receiving portion moving mechanism may be provided for horizontally moving the treatment liquid receiving portions 61, 62, 63 toward and away from the substrate holding mechanism 1. The treatment liquid receiving portion moving mechanism may be adapted to horizontally move the first to third treatment liquid receiving portions 61, 62, 63 unitarily, or may be an individual advancement/retraction mechanism which independently moves back and forth the first, second and third treatment liquid receiving portions 61, 62, 63 with respect to the substrate holding mechanism 1. Further, the substrate treatment apparatus may be arranged such that the substrate holding mechanism 1 is horizontally movable and the first to third treatment liquid receiving portions 61, 62, 63 are horizontally movable individually or unitarily.

While the four embodiments of the present invention have thus been described, the invention may be embodied in other ways. For example, in the embodiments described above, the attitude of the substrate W is changed between the horizontal attitude and the tilted attitude by moving up and down the support pins 31, 32, 33, but the attitude change of the substrate W may be achieved by tilting the base 4 or the entire substrate holding mechanism 1. Further, the attitude change of the substrate W may be achieved by tilting the entire substrate treatment apparatus.

In the embodiments described above, the two chemical agents and the deionized water (rinse water) are used, but three or more chemical agents or a single chemical agent may be used. More specifically, the number of the treatment liquid receiving portions is determined depending upon the number of the treatment liquids to be used for the treatment.

In the embodiments described above, the treatment liquid receiving portions are arranged along the outer periphery of the substrate W held by the substrate holding mechanism 1, or arranged in vertically stacked relation on the lateral side of the substrate holding mechanism 1 by way of examples. These arrangements may be employed in combination. In this case, plural sets of treatment liquid receiving portions arranged in vertically stacked relation are located at plural positions around the substrate holding mechanism 1. This makes it possible to separately drain a greater number of treatment liquids while suppressing the height of the substrate treatment apparatus.

The arrangements shown in FIGS. 6 and 7 may be employed in combination. In this case, the treatment liquid flow-down position of the substrate W relative to the treatment liquid receiving portions is changed by rotating the substrate holding mechanism 1 and rotating the first to third treatment liquid receiving portions 61, 62, 63.

In the arrangement shown in FIG. 8, the guide members 61b, 62b, 63b respectively project from the ceilings of the treatment liquid receiving portions 61, 62, 63 by way of example. Alternatively, the guide members 61b, 62b, 63b may project from inner bottom surfaces of the treatment liquid receiving portions 61, 62, 63.

Examples of the rinse liquid other than the deionized water include functional waters such as carbonated water, electrolyzed ion water, hydrogen water and magnetized water, and diluted ammonia water (e.g., having a concentration of about 1 ppm).

In the embodiments described above, the substrate holding mechanism 1 is adapted to hold the round substrate W by the three support pins 31, 32, 33 by way of example, but the substrate holding mechanism 1 may have four or more support pins for supporting the substrate W.

In the embodiments described above, the plurality of nozzles 11, 12, 13A, 13B are provided for supplying different types of treatment liquids including the chemical agents and the rinse liquid. Alternatively, the chemical agents and the rinse liquid may be each supplied from a single common nozzle. For example, two or more of the first chemical agent, the second chemical agent and the rinse liquid may be selectively supplied from a single nozzle connected to a valve mechanism.

Although the substrate treatment apparatuses according to the embodiments described above are each adapted to treat the round substrate, the present invention is applicable to a substrate treatment apparatus which is adapted to treat a rectangular substrate typified by a glass substrate for a liquid crystal display device.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2005-379664 filed to the Japanese Patent Office on Dec. 28, 2005, the disclosure of which is incorporated herein by reference.

What is claimed is:

1. A substrate treatment apparatus comprising:
a substrate holding mechanism which holds a substrate;
a substrate attitude changing mechanism which changes an attitude of the substrate held by the substrate holding mechanism between a generally horizontal attitude and a tilted attitude in which the substrate is tilted with respect to a horizontal plane;
a treatment liquid supplying mechanism which is capable of supplying a plurality of treatment liquids to the substrate held by the substrate holding mechanism;
a controlling unit which controls the substrate attitude changing mechanism so as to bring the substrate into the horizontal attitude when one of the treatment liquids is to be supplied onto the substrate held by the substrate holding mechanism from the treatment liquid supplying mechanism;
a plurality of treatment liquid receiving portions which each receive a corresponding one of the treatment liquids flowing down from a surface of the substrate when the substrate held by the substrate holding mechanism is brought into the tilted attitude by the substrate attitude changing mechanism; and
a receiving portion selecting unit which selects, according to the type of a treatment liquid present on the substrate held by the substrate holding mechanism, one of the treatment liquid receiving portions that is to receive the treatment liquid flowing down from the substrate kept in the tilted attitude.

2. A substrate treatment apparatus as set forth in claim 1, wherein the substrate holding mechanism holds the substrate in a non-rotative state in a period during which the surface of the substrate is covered with one of the treatment liquids.

3. A substrate treatment apparatus as set forth in claim 1, wherein when one of the treatment liquids is to be supplied onto the substrate held by the substrate holding mechanism from the treatment liquid supplying mechanism, the controlling unit controls the supply of the one treatment liquid from the treatment liquid supplying mechanism and controls the substrate attitude changing mechanism to bring the substrate into the horizontal attitude for retaining a puddle of the one treatment liquid on the substrate for a predetermined period for treatment of the substrate.

4. A substrate treatment apparatus as set forth in claim 1, wherein
the treatment liquid receiving portions are arranged along an outer periphery of the substrate held by the substrate holding mechanism, and
the receiving portion selecting unit includes a flow-down position/receiving position relative movement mechanism which changes a treatment liquid flow-down position relative to the treatment liquid receiving portions along the outer periphery of the substrate before the one treatment liquid flows down from the substrate brought into the tilted attitude by the substrate attitude changing mechanism.

5. A substrate treatment apparatus as set forth in claim 4, wherein the flow-down position/receiving position relative movement mechanism includes a tilt direction changing mechanism which changes a substrate tilt direction in which the substrate is tilted by the substrate attitude changing mechanism.

6. A substrate treatment apparatus as set forth in claim 5, wherein
the substrate holding mechanism includes at least three substrate support members which support a lower surface of the substrate,
the substrate attitude changing mechanism includes a substrate support level changing mechanism which relatively changes substrate support levels of the at least three substrate support members at which the substrate is supported by the respective substrate support members, and
the tilt direction changing mechanism controls the substrate support level changing mechanism to adjust the substrate support levels of the at least three substrate support members for changing the substrate tilt direction.

7. A substrate treatment apparatus as set forth in claim 4, wherein the flow-down position/receiving position relative movement mechanism includes a receiving portion rotating mechanism which rotates the plurality of treatment liquid receiving portions along the outer periphery of the substrate held by the substrate holding mechanism.

8. A substrate treatment apparatus as set forth in claim 1, wherein
the treatment liquid receiving portions are arranged in vertically stacked relation on a lateral side of the substrate holding mechanism, and
the receiving portion selecting unit includes a flow-down position/receiving position relative movement mechanism which, before the one treatment liquid flows down from the substrate brought into the tilted attitude by the substrate attitude changing mechanism, changes a treatment liquid flow-down position relative to the treatment liquid receiving portions for receiving the one treatment liquid.

9. A substrate treatment apparatus as set forth in claim 8, wherein the flow-down position/receiving position relative movement mechanism includes a substrate moving mechanism which moves the substrate holding mechanism relative to the treatment liquid receiving portions.

10. A substrate treatment apparatus as set forth in claim 8, wherein the flow-down position/receiving position relative movement mechanism includes a receiving portion moving mechanism which moves the treatment liquid receiving portions relative to the substrate holding mechanism.

11. A substrate treatment apparatus as set forth in claim 1, further comprising a treatment liquid guide member which guides the treatment liquid flowing down from the substrate kept in the tilted attitude by the substrate attitude changing mechanism into the corresponding treatment liquid receiving portion.

12. A substrate treatment apparatus as set forth in claim 11, wherein the treatment liquid guide member is arranged to be brought into contact with the treatment liquid flowing down from the substrate without contact with the substrate.

13. A substrate treatment apparatus as set forth in claim 1, further comprising an infrared emitting mechanism which emits infrared radiation toward the substrate held by the substrate holding mechanism.

14. A substrate treatment method comprising the steps of:
supplying a plural types of treatment liquids, in sequence, onto a substrate in a generally horizontal attitude;
holding the substrate in a tilted attitude to cause each of the treatment liquids to flow down from the substrate; and
receiving the treatment liquid flowing down from the substrate held in the tilted attitude in a treatment liquid receiving portion selected from a plurality of treatment liquid receiving portions according to the type of the treatment liquid to be received.
